(19) United States
(12) Patent Application Publication
(10) Pub. No.: US 2006/0034518 A1
(43) Pub. Date: Feb. 16, 2006

(54) Method of creating a subset of images from a library of images

(75) Inventors: James Thomas Edward McDonnell, Bristol (GB); Abigail Jane Sellen, Newbury (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY

(21) Appl. No.: 11/201,432

(22) Filed: Aug. 11, 2005

(30) Foreign Application Priority Data
Aug. 13, 2004 (GB) 0418089.9

(51) Int. Cl. G06K 9/62

(52) U.S. Cl. 382/224

(57) ABSTRACT

A method of creating a subset of images from a library of images is provided. There are a set of image prints of the images in the library and associated with each print is a memory tag with the digital data of the image stored within. The method includes the steps of locating the required images, using a reader to read the digital data of each of the images to be included in the subset from the relevant memory tags and downloading the selected subset of image data to a desired location.

### FIELD OF THE INVENTION

The invention relates to a method of creating a subset of images from a library of images where each image is stored in digital form and in physical form. The invention is primarily intended for use with photographic images and video clips but is not limited to such use.

### BACKGROUND OF THE INVENTION

Prior to the advent of digital photography most photographic images were stored as negatives and/or as image prints. To assist in maintaining and using a library of images, index prints, comprising a small print of each photograph from a film on a single sheet, were often produced. However, with the advent of digital photography, and the ability to scan photographs and store them electronically even if taken using traditional methods, the storage options have increased dramatically.

In many cases whole libraries of photographs are simply stored on the hard discs of computers, whilst in other cases they are stored on removable storage media, such as floppy discs or CDs. However, this often requires the use of a very large number of the removable storage media, particularly when floppy discs are used and, when a user wishes to locate a particular image and print a copy of it, finding it can be problem.

The problem can be exacerbated with pictures taken digitally as, when the contents of the storage medium used in the camera are dumped to computer for longer term storage, they are often simply dumped in the order they are in on the storage medium in the camera. If all pictures taken have been retained then they are at least in the order they were taken, but in many cases some images are reviewed some time after being taken and deleted, with those “slots” in the storage medium in the camera being reused later. This results in images being stored out of sequence, both in the storage medium in the camera and in the longer term storage in the computer hard disc or removable storage media.

Hence, in recent years various alternative systems for the selection and printing of images from such image libraries have been suggested. However none of the systems suggested so far make the management of such libraries as simple as might be the case.

It is an object of the present invention to provide a new method of managing a library of images, such as photographic images or video clips.

### SUMMARY OF THE INVENTION

According to one aspect of the invention there is provided a method of creating a subset of images from a library of images, there being a set of image prints of the images in the library and associated with each print a memory tag with the digital data of the image stored therein, the method including the steps of locating the required images, using a reader to read the digital data of each of the images to be included in the subset from the relevant memory tags and downloading the selected subset of image data to a desired location.

### BRIEF DESCRIPTION OF THE DRAWINGS

Examples of the invention will now be described, by way of example only, with reference to the accompanying drawings in which:

FIG. 1 schematically illustrates a first version of an index print with which the invention may be implemented;

FIG. 2 schematically illustrates a second version of an index print with which the invention may be implemented;

FIG. 3 schematically illustrates a memory tag and read/write device with which the invention may be implemented;

FIG. 4 is a flow diagram of a first embodiment of a method according to the invention, and

FIG. 5 is a flow diagram of a second embodiment of a method according to the invention.

### DETAILED DESCRIPTION OF THE PREFERRED EMBODIMENTS

As indicated above, in one aspect the invention provides a method of creating a subset of images from a library of images, there being a set of image prints of the images in the library and associated with each print a memory tag with the digital data of the image stored therein, the method including the steps of locating the required images, using a reader to read the digital data of each of the images to be included in the subset from the relevant memory tags and downloading the selected subset of image data to a desired location.

Memory tags in the form of Radio Frequency Identification (RFID) tags are well known in the prior art. RFID tags come in many forms but most comprise an integrated circuit including a memory, in which in use information can be stored, and a coil which enables the circuit to be wirelessly interrogated by a reader which also powers it by means of an inductive (wireless) coupling. Many uses of memory tags are already known, some of which relate to storage of data relating to images.

For example Eastman Kodak Company has proposed a range of applications relating to images, presumably intended for use with photographic images. In EP 1 076 316 A2 a single image print has a memory tag coupled to it which stores data concerning the print. The data is described as being to do with the manner in which the image was processed and printed, and the file name under which the full image data is stored in another location (such as in a computer or other higher capacity storage medium). In U.S. Pat. No. 6,363,239 B1 a single image print is described having a memory tag coupled thereto which stores audio data relating to the print. In both of these patent documents it is suggested that, if a single memory tag is not adequate for storage of the data relating to the single image concerned, then multiple memory tags may be used, specifically in a stack at the same location on the print substrate.

The invention provides assistance in making practical use of the developments in RFID technology, and indeed in any other memory tag technologies, in relation to the management of storage of digital images

The method according to the invention requires physical prints representative of the images within the library to be managed and, associated with each printed image, a memory tag containing the data including the digital form of that image. Also required is a reader/writer operable to read data from memory tags and then write or download it to another location, such as another memory tag or a computer.

The physical prints used to implement the method of the invention can take a large number of forms, some of which will now be described.

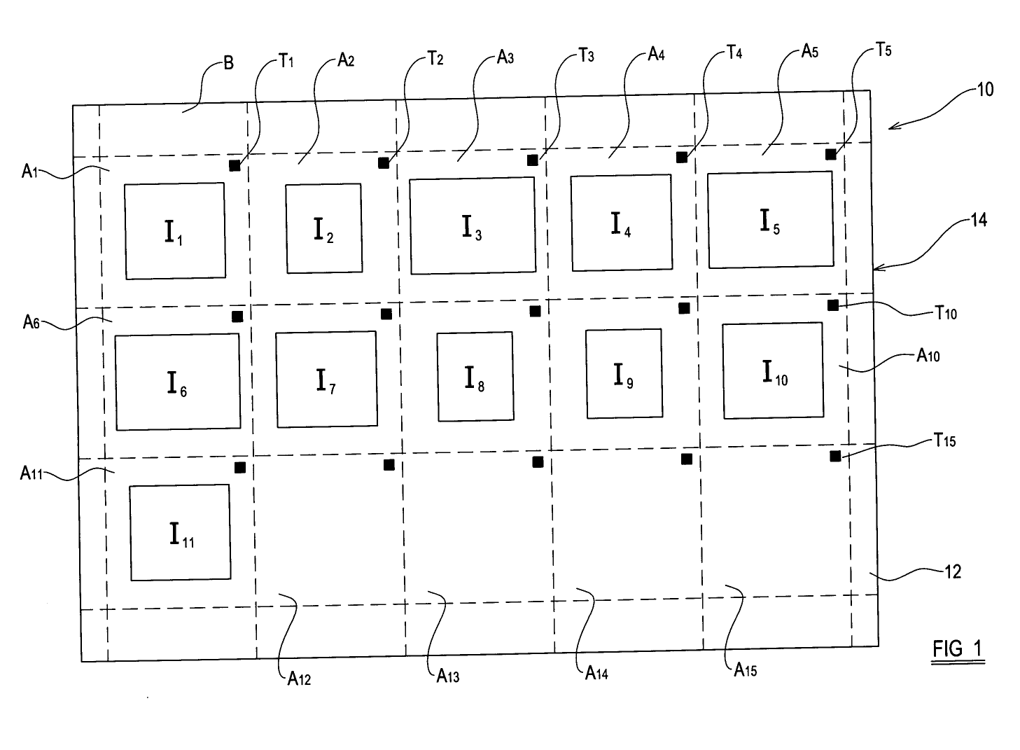

Referring to FIG. 1, an index print 10 comprising a plurality of images I on a substrate 12 is schematically illustrated. The area of the substrate 12 is nominally divided up into image areas A and a border B as illustrated by the chain lines. Each image area A can have an image I printed in it, and in this case areas A₁ to A₁₁ have images I₁ to I₁₁ respectively and areas A₁₂ to A₁₅ do not have images printed in them and are left blank. The images I are not of a particular size or relative dimensions, but rather vary as desired; they could however all be of the same size. Each area A has located within it, and coupled to the substrate 12, in this case top right of each area A, a memory Tag T. The memory tags T thus form a regular array on the substrate 12.

The index print 10 is provided as a readily usable record of the images I to assist in management of those images and others which might be included in the same collection or library. The images I are printed onto the substrate 12 (conveniently in low resolution but they may be printed in high resolution) and data relating to each image I is stored in the corresponding memory tag T. The data as a minimum includes the full image data probably in high resolution format (but it can be any desired format), and may further include data concerning the image such as the camera settings, light levels etc. from when it was formed and information such as where it was taken, what it is of and so on, although any data chosen may be stored in the memory tags T.

The substrate 12 and memory tags T combined form a print storage medium 14, i.e. a physical storage medium specifically adapted for the storage of data relating to a plurality of images both in visible printed form and in digital form.

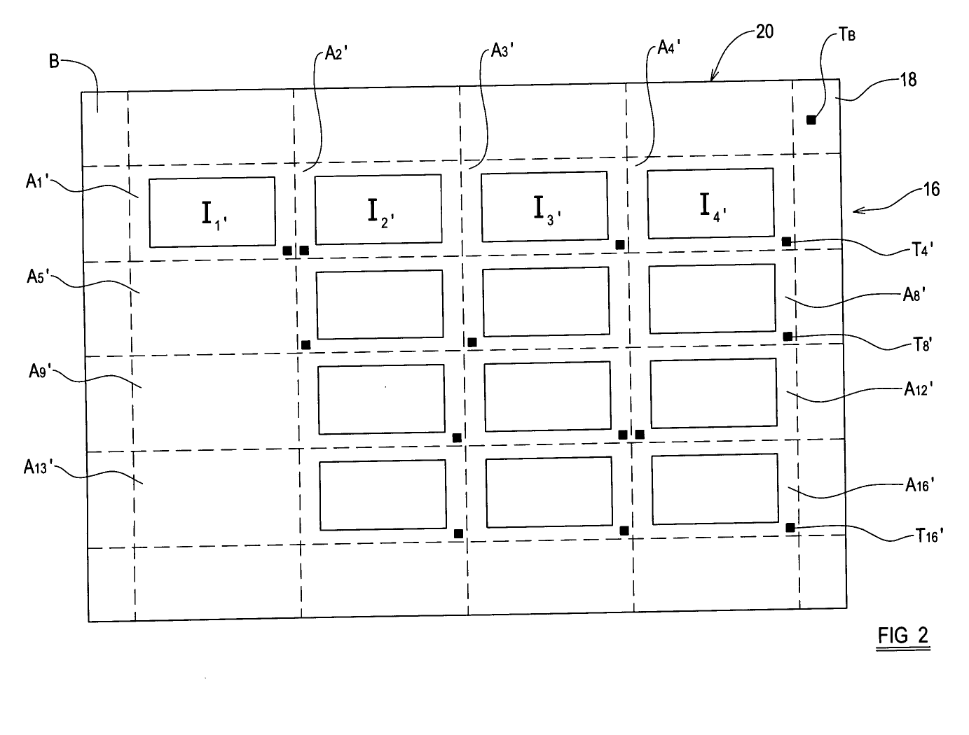

Referring now to FIG. 2 an alternative form of index print 16 is illustrated schematically. Similarly to the index print 10 it comprises a plurality of images I on a substrate 18 which is nominally divided up into image areas A and a border B as illustrated by chain lines. Each area A can have an image I printed in it, and in this case areas A_{1′} to A_{4′}, A_{6′} to A_{8′}, A_{10′} to A_{12′} and A_{14′} to A_{16′} have images I_{1′} to I_{4′}, 1_{6′} to I_{8′}, I_{10′} to I_{12′} and I_{14′} to I_{16′} respectively and areas A_{5′}, A_{9′} and A_{13′} do not have images and are left blank. The areas that contain images also each have within them a memory tag T. However these are not all located in the same place with respect to the area A in which they are located but rather with respect to the image I with which they are associated. That is they are all located bottom right of the respective image I, and thus their location within the area A depends on the orientation of the image I concerned, depending on whether the image I is in portrait or landscape format. In this version of an index print those areas without an image do not contain a memory tag T.

The substrate 18 and memory tags T combined form a print storage medium 20, as described above in respective of print storage medium 14.

A further modification to index prints of such kinds is the provision of a memory tag T_{B} located within the border of the substrate, as shown in FIG. 2. This memory tag T_{B} would conveniently have stored in it data concerning the index print 16 as a whole, such as a list of the images I on the index print 16, and their respective locations on the index print 16, including the locations of the memory tags T if appropriate.

Conveniently for all versions of index prints visible icons are printed at the location of each memory tag T such that users of the index prints can readily locate the memory tags T when seeking to read the data from them. This will be particularly beneficial where the user is using a hand held reader.

Clearly, other forms of index print may be formed with variations in the relative positions of the printed images I and the memory tags T, and with variations in the form of data stored in the memory tags T. In addition the physical prints may take the form of a single image printed on each sheet with the associated memory tag affixed thereto, albeit that this would be far less convenient to store (due to the bulk involved) and work with.

The images within the library may be still photographs, or other still images such as diagrams, maps, artwork, layouts of pages for books or other publications etc., in which case the print of each image will most conveniently simply display the image itself as described above. However, the images may be video clips, each of which comprises a plurality of frames. In this case the print of each image will most likely take the form of a subset of the frames which make up the video clip. This may simply be the first frame only, or any appropriately representative subset such as for examples the first few frames, every fifth frame, or the first and last frames. If the image is a video clip then the memory tag will contain the whole video clip.

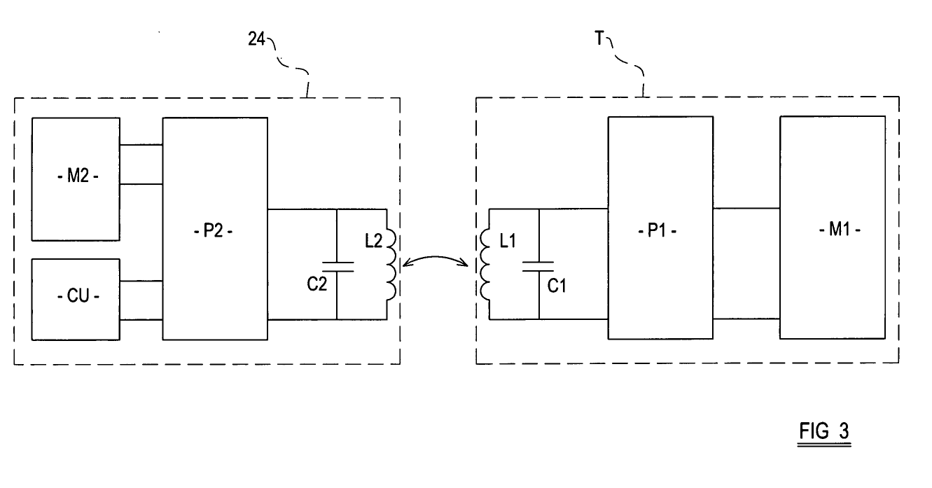

The operation of memory tags T and an associated read/write device 24 will now be described briefly with reference to FIG. 3. A memory tag T includes an antenna coil L1 and a capacitor C1 connected in parallel therewith to form a resonant circuit. It further includes a memory M1 and processing and power circuit P1. The read/write device 24 includes an antenna coil L2 and a capacitor C2 in parallel therewith to form a resonant circuit, a processing and signal generating circuit P2, an on-board memory M2, and a communication unit CU.

A signal generator within P2 generates a signal at the chosen frequency of operation, such as 2.45 GHz, and this is applied to the antenna coil L2 and thus generates an electromagnetic field which, provided the memory tag T is sufficiently close to the read/write device 24, penetrates the antenna coil L1 of the memory tag T. By induction a voltage is thus generated in the antenna coil L1, this is rectified in circuit P1 and used to power the memory tag T. The capacitance of the capacitors C1 and C2 is selected such that the resonant circuits are both resonant at the frequency generated by the signal generator, in order to maximise transmitted signal strength and received signal.

When data is to be written to the memory tag T by the read/write device 24 the radio frequency signal generated in P2 is modulated, e.g. amplitude modulated, with the data before being applied to the antenna coil L2 and transmitted. The signal received by the memory tag T by inductive coupling thus both powers the memory tag T and communicates with it, the circuit P1 separating the data signal from the carrier and passing data for storage to the memory M1.

Similarly, if data is to be read from the memory tag T, as in this invention, the circuit P1 applies a signal indicative of the data to the antenna coil L1 which is detected, as a result of the inductive coupling, by antenna coil L2 and deciphered in circuit P2 before being passed to the on-board memory M2 for temporary storage. This signal may for example be transmitted using load modulation. In RFID systems such as this the power consumed by the memory tag T can be measured as a drop in voltage across the internal resistance of the antenna coil L2 of the read/write device 24. A load resistance within the circuit P1 may be switched on and off, thus altering the power consumed by the memory tag T which is then detected as an amplitude modulation of the voltage across the antenna coil L2 of the read/write device 24.

When it is desired to download the data read into the read/write device 24 to a computer or alternative storage device (not shown) the read/write device 24 is operable to do so using the communication unit CU, for example using a docking station or via a wireless system such as infra red or Bluetooth.

For more detail concerning the operation of RFID tags the reader is referred to the RFID Handbook, Klaus Finkenzeller, 1999, John Wiley & Sons.

Thus it will be understood that communication with the memory tags T is via a read/write device 24. Read/write devices 24 can take many forms but most conveniently for the implementation of this invention may be a hand held pen type device. Instead of having an on-board memory as described above the read/write device may be connected directly to a computer such that everything read by the read/write device 24 is automatically stored in the memory of the computer or in associated storage media (such as a CD or DVD).

Preferably the read/write device 24 used for the implementation of this invention will also include a display, such as a small LCD screen, on which the images being read can be displayed during the method of the invention for the purpose of checking what has been read from a memory tag.

The method according to the invention will now be described.

When a user wishes to create a subset of images from a library of such images they take the physical record of the images, such as a collection of the index prints described above, and look through the physical record to locate the images they require. When they have located the first image required they use the read/write device 24 to read the contents of the associated memory tag T. The user then locates the second image required and uses the read/write device 24 to read the contents of the associated memory tag T. This process continues until the user has located all of the required images, in the desired order, and read the contents of the associated memory tags T into the memory M2 of the read/write device 24.

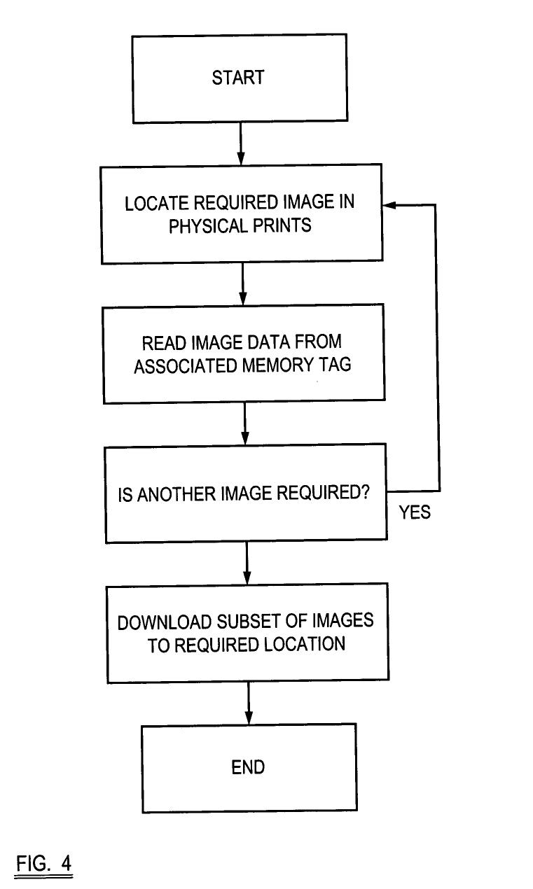

The memory M2 now contains the data for the required subset of images in the required order. The read/write device 24 is then operated to download the data for the subset of images from its memory M2 to the required location, such as a computer. This method is illustrated in FIG. 4.

If the read/write device is the kind which does not include an on-board memory but instead is connected to a computer the data for the subset of images will by then be in the memory of the computer.

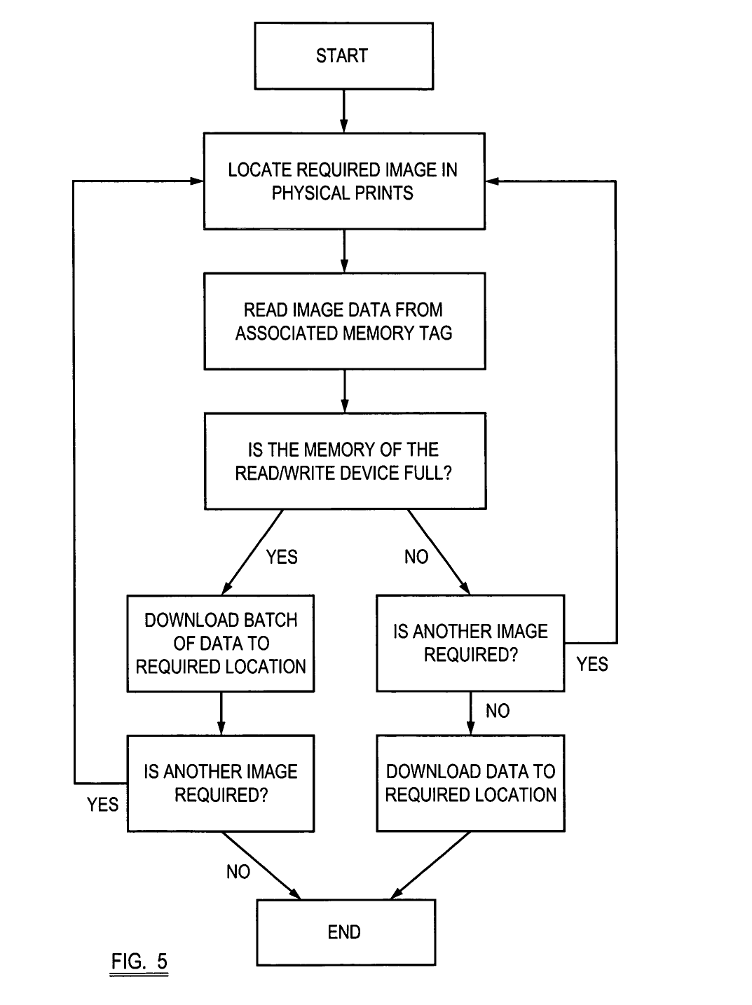

The above method, as illustrated in FIG. 4, assumes that the on-board memory M2 of the read/write device 24 is sufficiently large to store the data for the whole subset of images to be formed. However, if that is not the case, it may be necessary to create the subset in a series of batches, and the second embodiment of the invention includes this possibility as set out in FIG. 5.

Read/write devices 24 which are specifically intended for this use, possibly along with other uses, may be pre-programmed to perform the method with minimal intervention once it is commenced. For example, the reader may be programmed so that the user can input to the reader that it is to be used to collate a set of a predetermined number of images, say eight. Then the user would simply hold the read/write device 24 close to the eight memory tags T concerned in the correct sequence, such that the eight images could be read into the read/write device 24. The read/write device 24 would then not read any further data, even if held close to a further memory tag T in error, as it would have in it's memory the predetermined number of images, until such time as that subset had been downloaded and task which had been initiated had thus been concluded.

It should be noted that the read/write device 24 used for implementation of this invention need not be hand held, as described above, but may take other forms. For example it may comprise a device into which the index prints are fed, and which can be instructed to read the contents of the relevant memory tag(s) on each of such index print(s) in the required order. The use of the pre-programming described above would be particularly suitable for use with this form of read/write device 24, which might readily be controlled by a computer to which it is connected in a manner similar to a printer/scanner. In this case, rather than the user moving the read/write device 24 to each memory tag T in order, the identities and locations of the memory tags T from which data is to be read would be entered into the read/write device 24 if stand alone, or computer as appropriate, before the reading of data began. The read/write device 24 would then perform the implementation of the method. The pre-programming could also include the location to which the subset of image data should be downloaded once created.

It should also be noted that although the method is described being implemented using a read/write device 24 it is of course only necessary for the device concerned to be a reader, as the method does not necessarily require writing of the data once collated, but rather download by any means.

There are many reasons why one might wish to create a subset of images, in a particular order, from a library. Thus, the ability for a user to selectively capture and in doing so create their own sequence of images has many different potential and valuable uses. The following are a few of many possible examples: one might capture a subset of images in order to print that subset (by connecting directly to a printer, for example), for creating a personal slide show, for capturing a set of one's favourite photos to carry around on a PDA or phone (like an electronic photo flip book), for capturing photos off a friend's collection to take away, for creating a subset of pictures to electronically send to family or friends, or simply to create new, differently organised archives of photos to store elsewhere.

The term image has been used in describing this invention because the most likely use of the invention is in relation to sets of data which are usually described in this way, but it should be understood that the term is used in a very broad sense. The “image” may in reality be any set of data.

1. A method of creating a subset of images from a library of images, there being a set of image prints of the images in the library and associated with each image print a memory tag with the digital data of the image stored therein, the method including the steps of:
locating the required images
using a reader to read the digital data of each of the images to be included in the subset from the relevant memory tags, and
downloading the selected subset of image data to a desired location.

2. A method according to claim 1 wherein the digital data of the images to be included in the subset is read from the memory tags in the order in which the images are to appear in the subset.

3. A method according to claim 1 wherein the steps of locating each required image and reading the digital data of that image are undertaken in sequence for each image concerned until the selected subset of image data is complete.

4. A method according to claim 1 wherein the steps of locating the required images and reading the digital data of the images are undertaken for all images of the subset at a time.

5. A method according to claim 1 wherein the reader is pre-programmed to perform the method before reading of the digital data from the relevant memory tags commences.

6. A method according to claim 1 wherein the images in the library are still images, and the prints of the images are of the still images.

7. A method according to claim 1 wherein the images in the library are video clips each comprising a plurality of frames, and the prints of the images are representative of the video clips.

8. A method according to claim 7 wherein each print of an image representative of a video clip includes a subset of the frames comprising the respective video clip.

9. A reader for memory tags adapted to read digital data relating to a library of images comprising a set of image prints of the images in the library and associated with each image print a memory tag with the digital data of the image stored therein, the reader being adapted to read the digital data of each of the images to be included in a subset of the set of image prints from the relevant memory tags, and to download the selected subset of image data to a desired location whereby the reader can be pre-programmed to read digital data for a predetermined number of images before implementation of the method is commenced.

10. A reader according to claim 9 wherein the reader can also be pre-programmed with the locations of the predetermined number of memory tags from which the data is to be read.

11. A reader according to claim 9 wherein the reader can also be pre-programmed with the location to which the selected subset of image data, once collated, is to be downloaded.
